(19) United States
(12) Patent Application Publication
(10) Pub. No.: US 2017/0261839 A1
(43) Pub. Date: Sep. 14, 2017

(54) IMAGE PROCESSING DEVICE, IMAGE PROCESSING METHOD, AND COMPUTER-READABLE RECORDING MEDIUM

(71) Applicant: FUJITSU LIMITED, Kawasaki-shi (JP)

(72) Inventors: Kensuke HOTTA, Kawasaki (JP); Daiki TAMAGAWA, Kawasaki (JP); Taichi MURASE, Kawasaki (JP); Hiroyuki MAEKAWA, Kawasaki (JP); Koji HIRAMATSU, Ota (JP); Hidetoshi SUZUKI, Fuji (JP)

(73) Assignee: FUJITSU LIMITED, Kawasaki-shi (JP)

(21) Appl. No.: 15/607,465

(22) Filed: May 27, 2017

Related U.S. Application Data
(63) Continuation of application No. PCT/JP2014/082761, filed on Dec. 10, 2014.

(51) Int. Cl. G03B 17/54; G06T 19/00; H04N 9/31; G06F 3/041

(52) U.S. Cl. CPC G03B 17/54; G06F 3/0416; G06T 19/006; H04N 9/31

(57) ABSTRACT

An image processing device projects a projection image onto a projection plane. Then, the image processing device captures the projection plane. Then, the image processing device specifies a process performed on the projection image. Then, the image processing device changes, based on the specified process, a start trigger of the start of the process or a height threshold of an indicating member included in a captured image from the projection plane, the height threshold indicating a threshold which is used for judgement of a touch operation in which the indicating member comes into contact with the projection image of a release operation in which the indicating member is away from the projection image.

### CROSS-REFERENCE TO RELATED APPLICATION

This application is a continuation application of International Application PCT/JP2014/082761, filed on Dec. 10, 2014, and designating the U.S., the entire contents of which are incorporated herein by reference.

### FIELD

The embodiments discussed herein are related to an image processing device, an image processing method, and a computer-readable recording medium.

### BACKGROUND

Conventionally, there is a known system that operates a projection image projected by a projector by an indicating member, such as a hand, a finger, or the like. Specifically, this system detects the position of the hand by capturing the projection image projected by the projector by two cameras, calculates the distance to the hand by using a parallax of the tow cameras, and detects the tap operation performed on the projection image by the hand.

More specifically, the projector projects an image onto a contact surface from above the contact surface on which a finger comes into contact with the projection image and, then, the camera similarly captures an image from above the contact surface. Then, the system detects the area of the hand by converting the projected image to a color space, setting the upper limit and the lower limit to each of the axes of the color space, and extracting a skin color. In this way, the system detects the hand and the hand operation performed on the projection image projected by the projector and implements the function of a monitor and a touch panel in combination.

Patent Document 1: Japanese Laid-open Patent Publication No. 2014-203174

However, with the technology described above, the operability is poor at the time of operation of a projection image by using an indicating member, i.e., a hand or the like, such as an operation of displaying a portion of a captured image designated by a finger operation, a clipping operation of cutting out only the designated portion, or the like.

### SUMMARY

According to an aspect of an embodiment, an image processing device includes a processor configured to: project a projection image onto a projection plane; capture the projection plane; specify a process to be performed on the projection image; and change, based on the specified process, a start trigger of the start of the process or a height threshold of an indicating member included in a captured image from the projection plane, the height threshold indicating a threshold which is used for judgement of a touch operation in which the indicating member comes into contact with the projection image or a release operation in which the indicating member is away from the projection image.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating an example of the overall configuration of a system according to a first embodiment;

FIG. 2 is a functional block diagram illustrating the functional configuration of an image processing device 10 according to the first embodiment;

FIG. 3 is a schematic diagram illustrating an example of information stored in an apparatus parameter DB 12b;

FIG. 4 is a schematic diagram illustrating a two-point touch process;

FIG. 5 is a schematic diagram illustrating a drag process;

FIG. 6 is a flowchart illustrating the flow of a release judgement process;

FIG. 7 is a flowchart illustrating the flow of touch and release judgement processes;

FIG. 8 is a schematic diagram illustrating false detection;

FIG. 9 is a schematic diagram illustrating touch and release operations;

FIG. 10 is a functional block diagram illustrating the functional configuration of an image processing device 30 according to a second embodiment;

FIG. 11 is a schematic diagram illustrating an example of information stored in an extraction DB 32b;

FIG. 12 is a schematic diagram illustrating an example of indication points;

FIG. 13 is a schematic diagram illustrating an operation of depicting a line connecting indication points;

FIG. 14 is a schematic diagram illustrating an operation at the time of cancellation;

FIG. 15 is a flowchart illustrating the flow of an area confirming process according to the second embodiment;

FIG. 16 is a flowchart illustrating the flow of a position specifying process;

FIG. 17 is a schematic diagram illustrating an example of the hardware configuration of an image processing device according to the first embodiment and the second embodiment; and

FIG. 18 is a schematic diagram illustrating an example of the hardware configuration of an image processing device according to the first embodiment and the second embodiment.

### DESCRIPTION OF EMBODIMENTS

Preferred embodiments will be explained with reference to accompanying drawings.

Furthermore, the present invention is not limited to the embodiments. Furthermore, the embodiments can be appropriately used in combination as long as processes do not conflict with each other.

### [a] First Embodiment

Overall Configuration

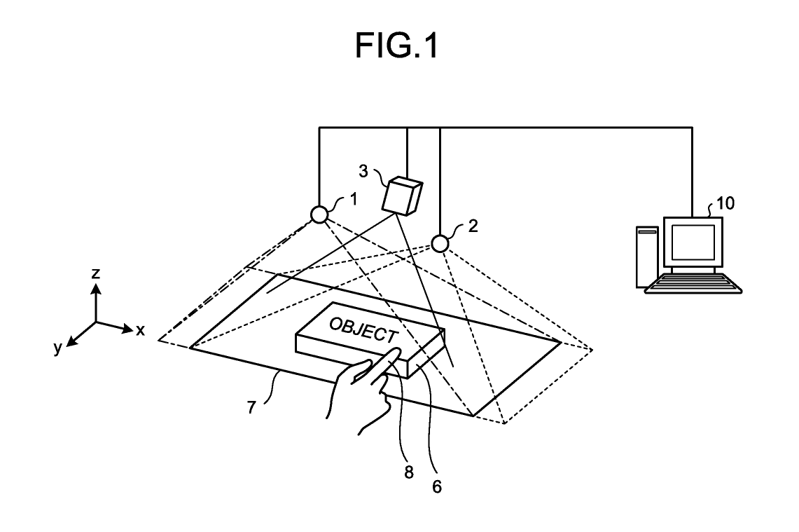

FIG. 1 is a schematic diagram illustrating an example of the overall configuration of a system according to a first embodiment. As illustrated in FIG. 1, this system is an example of a projector system that includes a camera 1, a camera 2, a projector 3, and an image processing device 10.

Specifically, the projector 3 projects an image or the like held in the image processing device 10 onto a projection plane 6 (hereinafter, sometimes referred to as a “projection image”). For example, as illustrated in FIG. 1, the projector 3 projects an image from the above, i.e., from the direction of the Z-axis, onto a projection plane. Furthermore, the X-axis is the lateral direction of a mounting board 7 that includes a projection plane and the y-axis direction is the depth direction of the mounting board 7.

The camera 1 and the camera 2 capture the projection plane 6, i.e., an object, that is projected by the projector 3. For example, as illustrated in FIG. 1, the camera 1 and the camera 2 capture a projection image from above the projection plane, i.e., from the Z-axis direction.

Then, the image processing device 10 detects the position of an indicating member, such as a finger, a hand, or the like, from the captured image captured by the two cameras, calculates the direction and the distance to the indicating member by using the parallax of the two cameras, and detects a tap operation or the like performed on the object. Furthermore, in the embodiment, an example of using a finger 8 as the indicating member will be described as an example.

In this state, the image processing device 10 projects the projection image onto the projection plane 6 and captures the projection plane 6. Then, the image processing device 10 specifies the process to be performed on the projection image. Thereafter, the image processing device 10 changes, based on the specified process, a height threshold of the indicating member included in the captured image from the projection plane. The height threshold is used for judgement of a touch operation in which the indicating member comes into contact with the projection image or a release operation in which the indicating member is away from the projection image. Alternatively, the image processing device 10 changes one of start triggers of the specified process.

Namely, when the image processing device 10 captures the projection image by each of the cameras and implements the operation by using a finger, the image processing device 10 dynamically changes, in accordance with the type of operation, the height threshold that is used for the judgement of a touch or a release of the finger or the number of protection stages of the captured frames used for the judgement. Consequently, the image processing device 10 can improve the operability at the time of the operation of the projection image by using the indicating member, such as a finger, or the like. Furthermore, in the embodiment, a description will be given of a case of using a finger as an example of the indicating member; however, the process can be similarly performed by using a hand, an indicating rod, or the like.

Functional Configuration

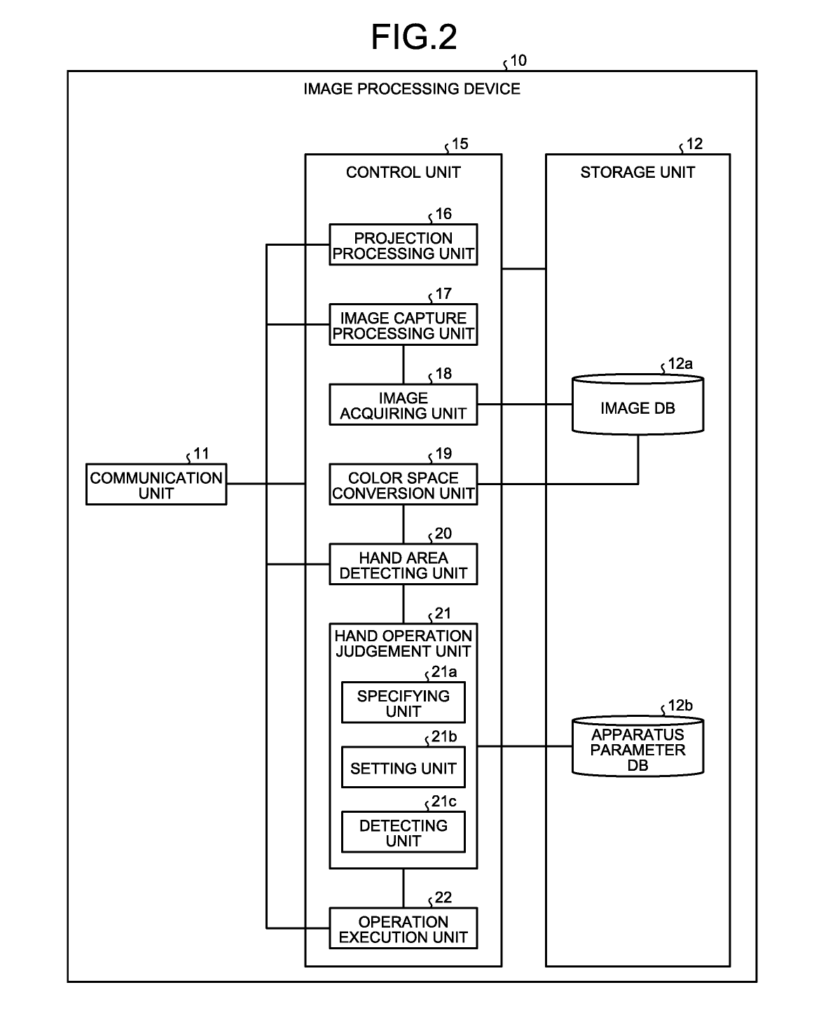

FIG. 2 is a functional block diagram illustrating the functional configuration of the image processing device 10 according to the first embodiment. As illustrated in FIG. 2, the image processing device 10 includes a communication unit 11, a storage unit 12, and a control unit 15.

The communication unit 11 is a processing unit that controls communication of other devices by using wired communication or wireless communication and is, for example, a communication interface, or the like. For example, the communication unit 11 sends an indication, such as the start or the stop of capturing an image, to the camera 1 and the camera 2 and receives the images captured by the camera 1 and the camera 2. Furthermore, the communication unit 11 sends an indication, such as the start or the stop of capturing an image, to the projector 3.

The storage unit 12 is a storage device that stores therein programs or various kinds of data executed by the control unit 15 and is, for example, a memory, a hard disk, or the like. The storage unit 12 stores therein an image DB 12a and an apparatus parameter DB 12b.

The image DB 12a is a database that stores therein images captured by each of the cameras. For example, the image DB 12a stores therein images, i.e., image frames, captured by each of the cameras. Furthermore, the image DB 12a stores therein data, size information, position information, a display state, and the like related to the area that is selected at the time of clipping operation performed on the projection image. Furthermore, the image DB 12a stores therein analysis results that include position information on a finger specified by image recognition, the content of a tap operation, and the like.

The apparatus parameter DB 12b is a database that stores therein a judgement condition for judging the start of the touch operation in which the finger 8 comes into contact with the projection plane or the start of the release operation in which the finger 8 is away from the projection plane. The information stored here is registered or updated by an administrator, or the like.

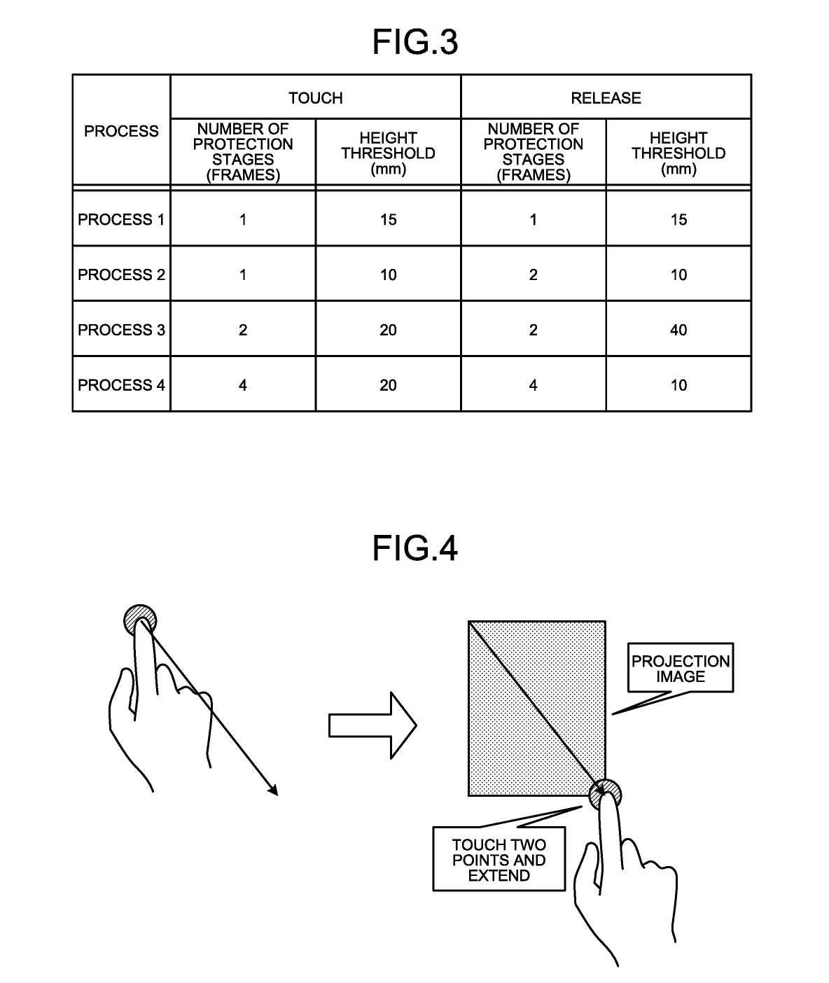

FIG. 3 is a schematic diagram illustrating an example of information stored in the apparatus parameter DB 12b. As illustrated in FIG. 3, the apparatus parameter DB 12b stores therein, in an associated manner, “a process, a touch (the number of protection stages and the height threshold), and a release (the number of protection stages and the height threshold)”.

The “process” stored here indicates various kinds of processes performed on the projection image and is, for example, a two-point touch process, a drag process, or the like. The “touch” indicates the touch operation in which the finger 8 comes into contact with the projection plane and the “release” indicates the release operation in which the finger 8 is away from the projection plane.

The “height threshold” indicates the height of the finger that is used to judge the start of the touch operation or the release operation, indicates the height in the Z-axis direction from the object that is the projection image, and is indicated in units of millimeters. The “number of protection stages” is information indicating that the start of the touch operation or the release operation is to be judged by using what number of the captured image from among the captured images in which it has been judged that the finger 8 exceeds the height threshold. The “number of protection stages” is indicated in units of the number of frames.

In a case of FIG. 3, a process 1 indicates that it is judged that a first captured image located after the captured images each of which includes therein the finger 8 located at the position at the height equal to or less than 15 mm is ignored and it is judged that the touch operation is started from a second captured image. Furthermore, the process 1 indicates that it is judged that the first captured image located after the captured images each of which includes therein the finger 8 located at the position at the height equal to or greater than 15 mm is ignored and it is judged that the release operation is started from the second captured image.

Here, for example, the process 1 is the default value and is used for an undefined process or the like. Furthermore, a process 2 is a two-point touch process, a process 3 is a drag process of a projection image, a process 4 is a scroll process of the projection image, or the like.

Furthermore, regarding the touch operation and the release operation, the same number of protection stages or the same height threshold may also be set; however, because, in a process, such as a drag process, or the like, in which a direct contact to an image is performed, an error tends to occur in detection of the finger 8, the number of protection stages is increased and the height threshold is also set to high. By doing so, dragging is less likely to be cut out. Furthermore, in the process of touching two points, the number of protection stages of the touch operation and the release operation is decreased so as to smoothly perform the touch operation and the release operation.

As an example, the two-point touch process and the drag process are described. FIG. 4 is a schematic diagram illustrating a two-point touch process. As illustrated in FIG. 4, the two-point touch process is the process in which the finger 8 selects and extends the projection image and is the process of designating the positions before and after the dragging. Furthermore, the process includes the process in which the finger 8 selects a projection image and reduces the projection image.

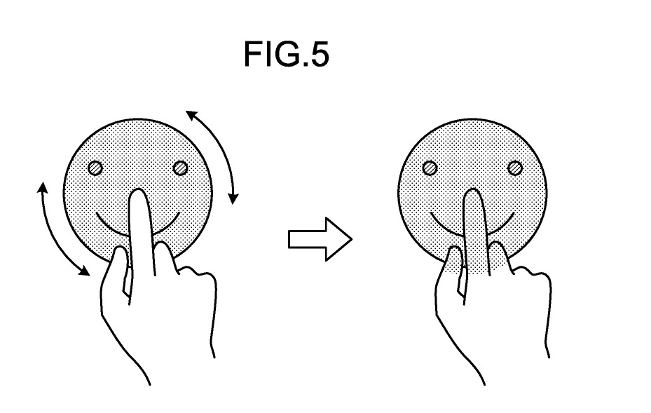

FIG. 5 is a schematic diagram illustrating a drag process. As illustrated in FIG. 5, the drag process is a process in which the finger 8 selects a projection image, rotates, and moves the projection image. The projection image is moved in accordance with the movement of the finger 8.

The control unit 15 is a processing unit that manages the overall image processing device 10 and is, for example, an electronic circuit, such as a processor, or the like. The control unit 15 includes a projection processing unit 16, an image capture processing unit 17, an image acquiring unit 18, a color space conversion unit 19, a hand area detecting unit 20, a hand operation judgement unit 21, and an operation execution unit 22. Furthermore, the projection processing unit 16, the image capture processing unit 17, the image acquiring unit 18, the color space conversion unit 19, the hand area detecting unit 20, the hand operation judgement unit 21, and the operation execution unit 22 are an example of an electronic circuit or an example of a process performed by the processor.

The projection processing unit 16 is a processing unit that performs control of projection to the projector 3. For example, the projection processing unit 16 sends an indication, such as the start or the stop of the projection with respect to the projector 3. Furthermore, the projection processing unit 16 controls the luminous at the time of projection performed onto the projector 3.

The image capture processing unit 17 is a processing unit that performs control of image capturing with respect to the camera 1 and the camera 2. For example, the image capture processing unit 17 sends an indication, such as the start of image capturing, or the like, to each of the cameras and allows each of the cameras to capture an image onto the projection plane.

The image acquiring unit 18 is a processing unit that acquires a captured image and that stores the captured image in the image DB 12a. For example, the image acquiring unit 18 acquires, from each of the cameras, the captured image obtained such that the image capture processing unit 17 allows each of the cameras to capture and then stores the acquired captured image in the image DB 12a.

The color space conversion unit 19 is a processing unit that converts the captured image to a color space. For example, the color space conversion unit 19 reads a captured image from the image DB 12a, converts the read captured image to a color space, and sets the upper limit and the lower limit on each of the axes of the color space. Then, the color space conversion unit 19 outputs the image converted to the color space to the hand area detecting unit 20.

Furthermore, every time a captured image is stored in the image DB 12a, the color space conversion unit 19 reads the latest captured image and performs conversion of the color space. Furthermore, regrading conversion of the color space, generally used image processing can be used.

The hand area detecting unit 20 is a processing unit that detects the area of the finger 8 from the captured image. For example, the hand area detecting unit 20 extracts a skin color area from an image that is converted to a color space by the color space conversion unit 19 and then detects the extracted area as a hand area. Then, the hand area detecting unit 20 outputs the extracted hand area or the captured image to the hand operation judgement unit 21.

The hand operation judgement unit 21 is a processing unit that includes a specifying unit 21a, a setting unit 21b, and a detecting unit 21c and that judges, by using these units, the touch operation in which the finger 8 comes into contact with the captured image, the release operation in which the finger 8 that is in a contact state is away from the captured image, or the like.

The specifying unit 21a is a processing unit that specifies a process performed on the projection image. Specifically, if the two-point touch process, the drag process, or the like is performed on the projection image, the specifying unit 21a specifies the process and notifies the setting unit 21b of the information on the specified process.

For example, the specifying unit 21a can specify the process by receiving a process targeted to be performed from a user or the like before the start of the process. Furthermore, the specifying unit 21a can also specify the process in operation by acquiring the operation content or the like from the operation execution unit 22, which will be described later.

The setting unit 21b is a processing unit that sets the height threshold and the number of protection stages in accordance with the process performed. Specifically, the setting unit 21b specifies, from the apparatus parameter DB 12b, the height threshold and the number of protection stages that are associated with the process notified from the specifying unit 21a and then notifies the detecting unit 21c of the specified result.

For example, if the setting unit 21b receives a notification of the two-point touch process (the process 2 in FIG. 3) from the specifying unit 21a, the setting unit 21b specifies “the touch (the number of protection stages: 1 and the height threshold: 10) and the release (the number of protection stages: 2 and the height threshold: 10)” associated with the process 2 and then notifies the detecting unit 21c of the result.

The detecting unit 21c is a processing unit that detects the touch operation or the release operation by using the height threshold and the number of protection stages notified from the setting unit 21b. Specifically, the detecting unit 21c detects, from the image notified from the hand area detecting unit 20, a change in the height positioned by the finger 8 and detects the touch operation if the height threshold and the number of protection stages of the touch operation are satisfied. Similarly, the detecting unit 21c detects, from the image notified from the hand area detecting unit 20, a change in the height positioned by the finger 8 and detects the release operation if the height threshold and the number of protection stages of the release operation are satisfied.

For example, the detecting unit 21c receives, from the setting unit 21b, a notification of “the touch (the number of protection stages: 1 and the height threshold: 10) and the release (the number of protection stages: 2 and the height threshold: 10)” associated with the two-point touch process (the process 2). Then, from among the sequentially captured images in which the height of the finger 8 becomes equal to or less than 10 mm from the height above 10 mm, the detecting unit 21c detects that the second captured image is the start of the touch operation. Namely, because the number of protection stages is one, the detecting unit 21c ignores the first captured image that satisfies the height threshold and judges that the second captured image is the start of the touch operation.

Furthermore, from among the sequentially captured images in which the height of the finger 8 becomes equal to or greater than 10 mm from the height above 10 mm, the detecting unit 21c detects that the third captured image is the start of the release operation. Namely, because the number of protection stages is two, the detecting unit 21c ignores the first and the second captured images that satisfy the height threshold and judges that the third captured image is the start of the release operation.

Then, the detecting unit 21c outputs, to the operation execution unit 22, the captured images positioned after the detection of the touch operation or the release operation. The height mentioned here is the distance between a finger and an object (a projection image or a projection plane), i.e., the distance from the object in the Z-axis direction. Furthermore, if the detecting unit 21c detects a captured image including a finger without receiving information, such as the height threshold, or the like, from the setting unit 21b, the detecting unit 21c performs judgement of the touch operation of the release operation by using the default value. Namely, the detecting unit 21c reads information associated with the process 1 from the apparatus parameter DB 12b and uses the information for the judgement.

The operation execution unit 22 is a processing unit that performs various kinds of operations on a projection image. Specifically, the operation execution unit 22 specifies a process by the trajectory of the finger 8 in the captured image that is input from the detecting unit 21c and then performs the subject process.

For example, the operation execution unit 22 detects a two-point touch operation, a drag operation, or the like from the captured image that is input after the touch operation has been detected and then performs the subject process. Furthermore, the operation execution unit 22 detects the end of the two-point touch operation, the drag operation, or the like from the captured image that is input after the release operation has been detected and then performs various kinds of processes.

Furthermore, if the operation execution unit 22 is notified from the specifying unit 21a of the content of the process that is to be performed from now, the operation execution unit 22 specifies the trajectory of the position of the finger 8 from the captured image notified from the detecting unit 21c and performs the notified process by using the specified trajectory.

Flow of the Process

In the following, various kinds of processes performed by the image processing device 10 according to the first embodiment will be described. Furthermore, here, the release judgement process, the touch process, and the release judgement process will be described.

Release Judgement Process

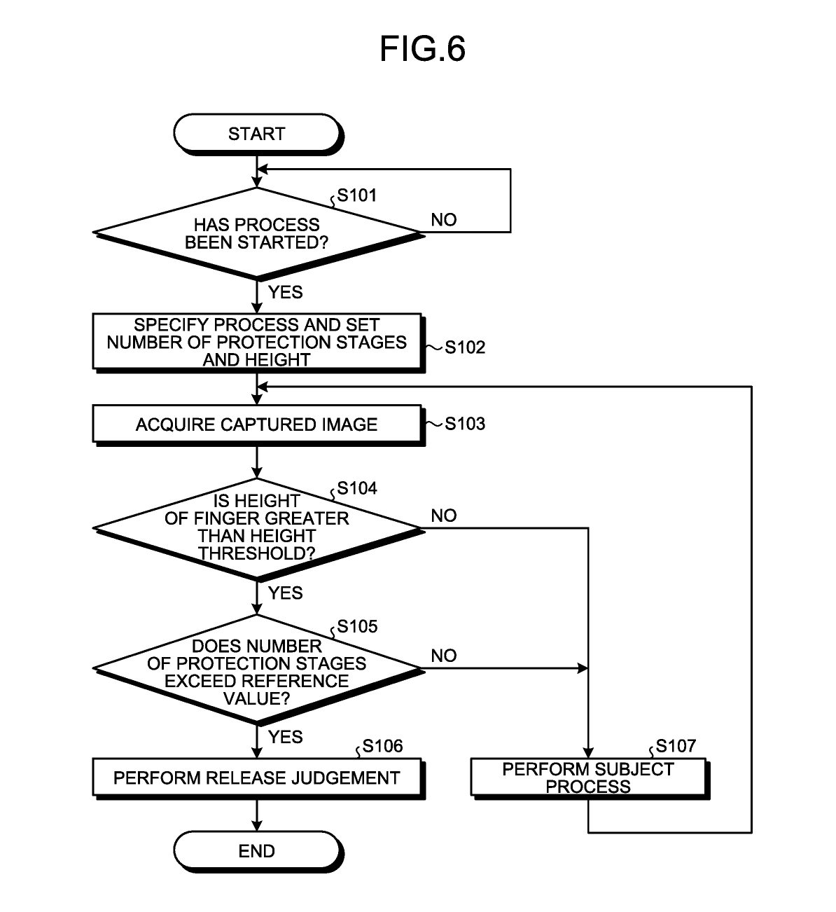

An example of the process performed is a case in which, after touch judgement is performed by default, the release process is judged by the height threshold and the number of protection stages that are in accordance with the process. FIG. 6 is a flowchart illustrating the flow of a release judgement process.

As illustrated in FIG. 6, if a process is started by the operation execution unit 22 (Yes at Step S101), the specifying unit 21a specifies the process that is being performed and specifies the subject release (the height threshold and the number of protection stages) from the apparatus parameter DB 12b (Step S102).

Then, the detecting unit 21c acquires a captured image via various kinds of processing units or the like (Step S103) and judges, if the height of the finger 8 is greater than the set height threshold (Yes Step S104) and if the number of captured images exceeds the reference value of the number of protection stages (Yes at Step S105), that the release operation has been performed (Step S106).

In contrast, if the height of the finger 8 is equal to or less than the set height threshold (No at Step S104) and if the number of captured images does not exceed the reference value of the number of protection stages (No at Step S105), the operation execution unit 22 subsequently performs the subject process (Step S107). Then, the process at Step S103 and the subsequent Steps are repeatedly performed.

Touch and Release Judgement Processes

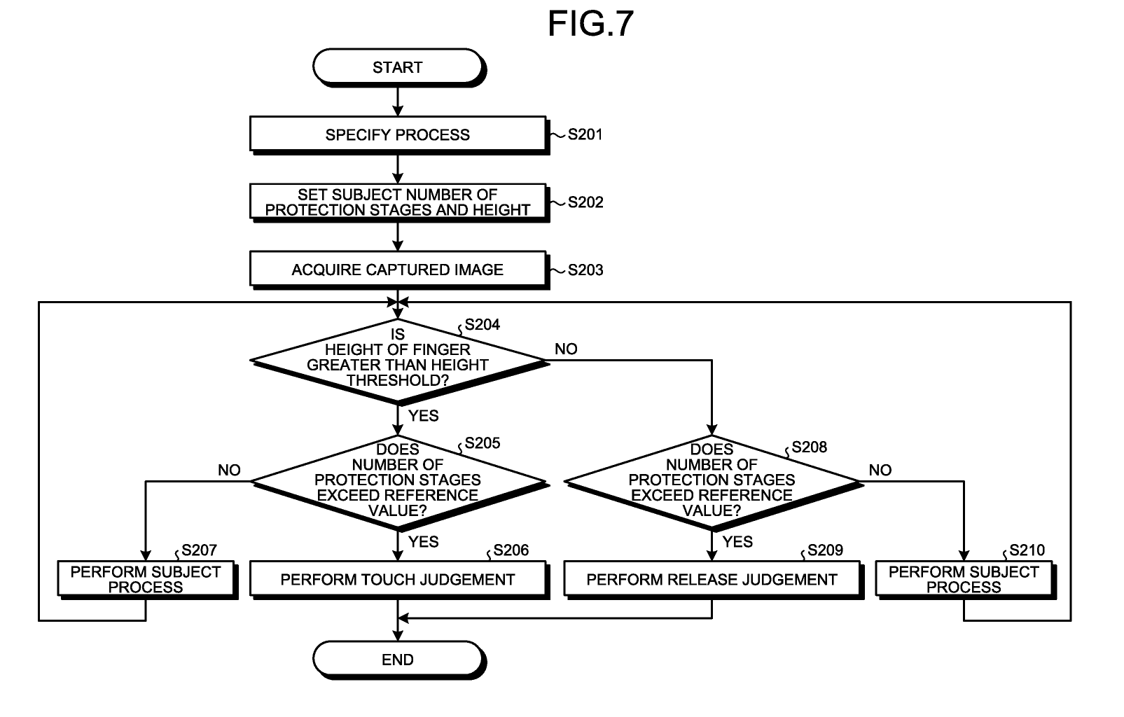

An example of the process performed is a case in which the process that is to be performed from now is specified by the specifying unit 21a. FIG. 7 is a flowchart illustrating the flow of the touch and the release judgement processes.

As illustrated in FIG. 7, the specifying unit 21a specifies the process to be performed (Step S201) and specifies the subject height threshold and the number of protection stages from the apparatus parameter DB 12b (Step S202).

Subsequently, the detecting unit 21c acquires a captured image via various kinds of processing units or the like (Step S203) and judges, if the height of the finger 8 is equal to or less than the set height threshold (Yes at Step S204) and if the number of captured images exceeds the reference value of the number of protection stages (Yes at Step S205), that the touch operation has been performed (Step S206).

In contrast, if the number of captured images does not exceed the reference value of the number of protection stages (No at Step S205), the operation execution unit 22 subsequently performs the subject process (Step S207). Then, the processes at Step S203 and the subsequent Steps are repeatedly performed.

Furthermore, at Step S204, if the height of the finger 8 is greater than the set height threshold (No at Step S204) and if the number of captured images exceeds the reference value of the number of protection stages (Yes at Step S208), the detecting unit 21c judges that the release operation has been performed (Step S209).

In contrast, the number of captured images does not exceed the reference value of the number of protection stages (No at Step S208), the operation execution unit 22 subsequently performs the subject process (Step S210). Then, the processes at Step S203 and the subsequent Steps are repeatedly performed.

Effect

As described above, because the image processing device 10 can dynamically change the height threshold or the number of protection stages in accordance with the content of the process to be performed, an optimum threshold can be set and thus it is possible to reduce false detection of the touch operation or the release operation.

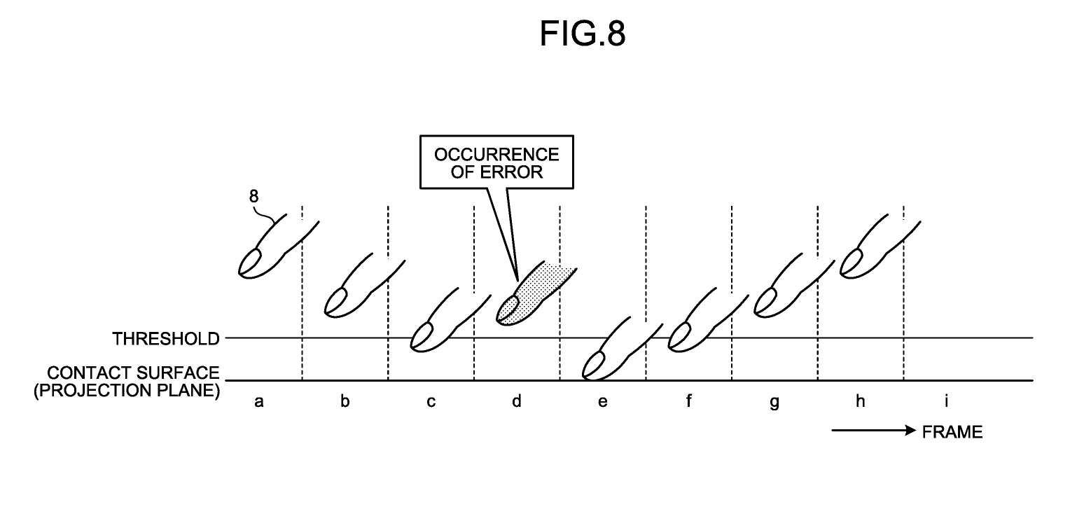

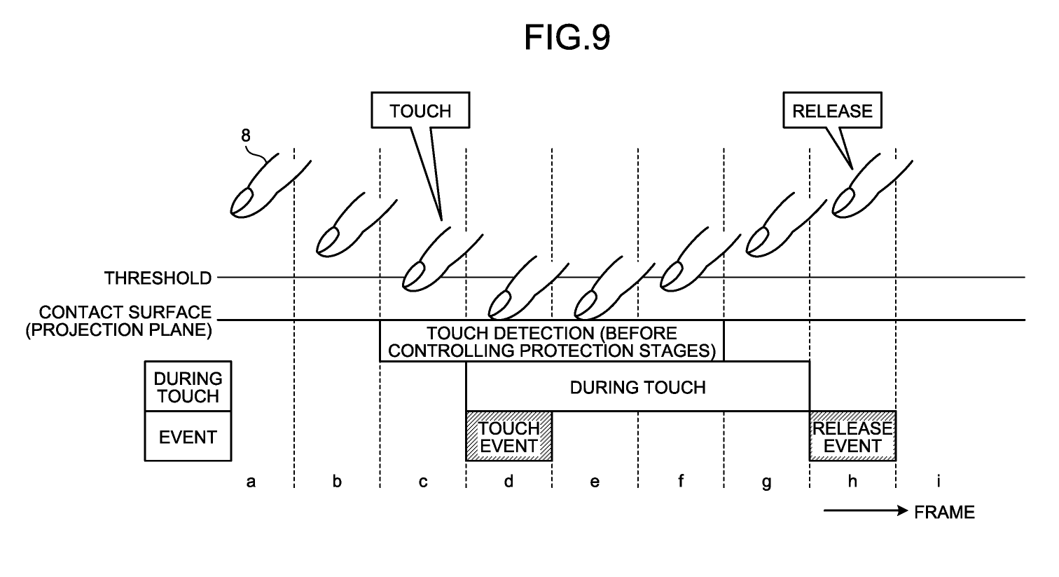

Here, a description will be given of an example of the false detection of the touch operation in a case where the height threshold or the like is fixed and an example of reduction of false detection in a case where the image processing device 10 according to the first embodiment is used. FIG. 8 is a schematic diagram illustrating the false detection and FIG. 9 is a schematic diagram illustrating the touch and the release operations. Furthermore, FIG. 9, the number of protection stages at the time of touch and release is set to one.

As illustrated in FIG. 8, conventionally, if the finger 8 is detected by a frame a that is captured by each of the cameras and it is detected that the height of the finger 8 becomes equal to or less than the threshold in a frame c, this frame c corresponds to the start of the touch operation. However, if an error occurs in a subsequent frame d and the height of the finger 8 exceeds the threshold, the touch operation ends and the release operation is detected. Furthermore, if the height of the finger 8 in a subsequent frame e becomes equal to or less than the threshold, the touch operation is detected.

In this way, conventionally, an event in which the touch operation and the release operation are frequently occurs due to the false detection sometimes occurs and, in some cases, the actual process is not correctly detected. Namely, conventionally, an erroneous operation occurs at the time of the operation of designating the touch or the release due to a clipping process.

In contrast, as illustrated in FIG. 9, the image processing device 10 according to the first embodiment detects the finger 8 by the frame a captured by each of the cameras and detects that the height of the finger 8 becomes equal to or less than the threshold in the frame c; however, because the number of protection stages is one, the image processing device 10 ignores the detection of the frame c. Then, because the height of the finger 8 is equal to or less than the threshold in the subsequent frame d, the image processing device 10 detects that the frame d is the start of the touch operation (touch event).

Regarding the release operation, similarly, after the image processing device 10 detects that the height of the finger 8 becomes greater than the threshold in a frame g, because the height of the finger 8 is greater than the threshold in a subsequent frame h, the image processing device 10 detects that the frame h is the start of the release operation (release event). Furthermore, during the period of time of each event corresponds to during the touch, i.e., during the period of time in which the process is being performed.

As described above, the image processing device 10 according to the first embodiment can reduce an erroneous operation in a case where the projection image from the projector 3 is directly operated by a hand and can improve an operational feeling at the operation.

### [b] Second Embodiment

Incidentally, in the first embodiment, a description has been given of an example in which the image processing device 10 accurately detects the touch operation or the release operation; however, the useful process performed by the image processing device 10 is not limited to this. For example, the image processing device 10 can cut out a designated range of a projection image and can improve the accuracy at that time.

Thus, in a second embodiment, an example of cutting out the designated range of the projection image will be described. Furthermore, in the second embodiment, a description will be given as the image processing device 30; however, because the overall configuration is the same as that described in the first embodiment, descriptions thereof in detail will be omitted.

The image processing device 30 according to the second embodiment projects a projection image onto the projection plane 6 and captures an image onto the projection plane 6. During the period of time in which the finger 8 is included in the designated range of the captured image that has been captured, the image processing device 30 depicts the line sequentially connecting the designated positions designated by the finger 8 on the projection image. Then, if the finger 8 moves outside the designated range of the captured image, the image processing device 30 traces back to a predetermined indicated position from among the designated indicated positions and then deletes, from the projection image, the line connecting the indicated positions that are designated after the predetermined indicated position.

Namely, if the finger 8 moves outside the designated range when selecting an area with respect to the projection image, the last side of the area to be selected disappears and the image processing device 30 returns to the last point of the previous side. Thus, the image processing device 30 can speedily perform the operation due to the clipping process.

Functional Configuration

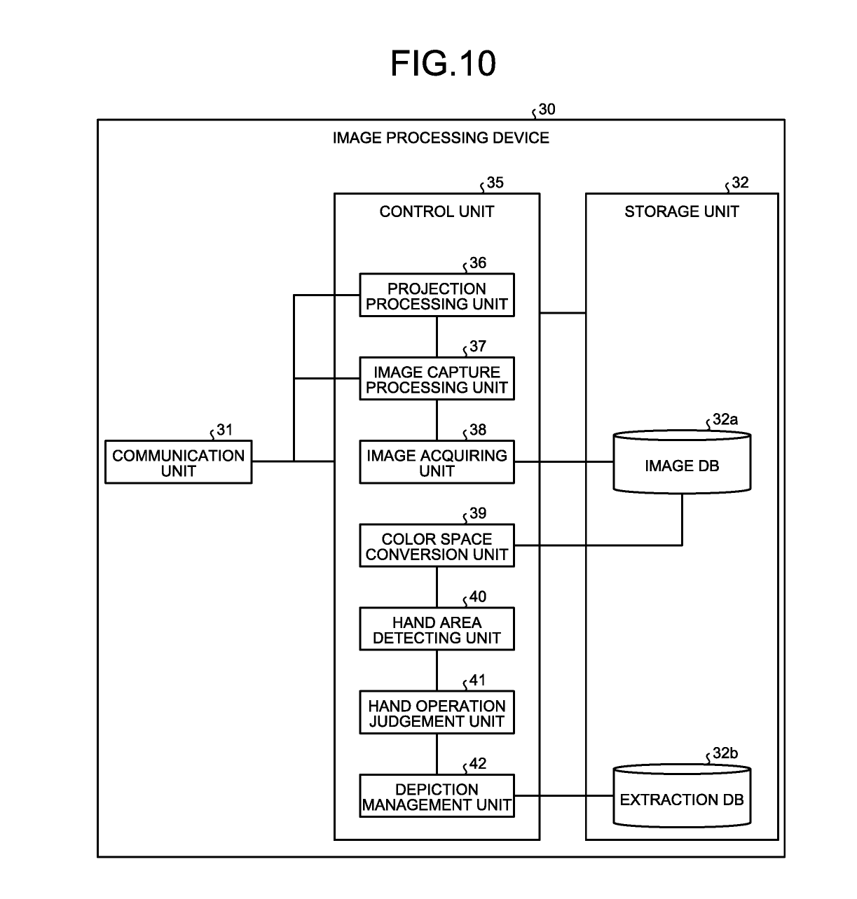

FIG. 10 is a functional block diagram illustrating the functional configuration of the image processing device 30 according to a second embodiment. As illustrated in FIG. 10, the image processing device 30 includes a communication unit 31, a storage unit 32, and a control unit 35.

The communication unit 31 is a processing unit that controls communication with another device by using wired communication or wireless communication and is, for example, a communication interface, or the like. For example, the communication unit 31 sends an indication, such as the start or the stop of image capturing, to the camera 1 and the camera 2 and receives the images captured by the camera 1 and the camera 2. Furthermore, the communication unit 31 sends an indication, such as the start or the stop of image projection, to the projector 3.

The storage unit 32 is a storage device that stores therein programs and various kinds of data executed by the control unit 35 and is, for example, a memory, a hard disk, or the like. The storage unit 32 stores therein an image DB 32a and an extraction DB 32b.

The image DB 32a is a database that stores therein images or the like captured by each of the cameras. For example, the image DB 32a stores therein the images captured by each of the cameras, i.e., image frames. Furthermore, the image DB 32a stores therein data, size information, position information, a display state, and the like related to the area that is selected at the time of clipping operation performed on the projection image. Furthermore, the image DB 32a stores therein analysis results that include position information on a finger specified by image recognition, the content of a tap operation, and the like.

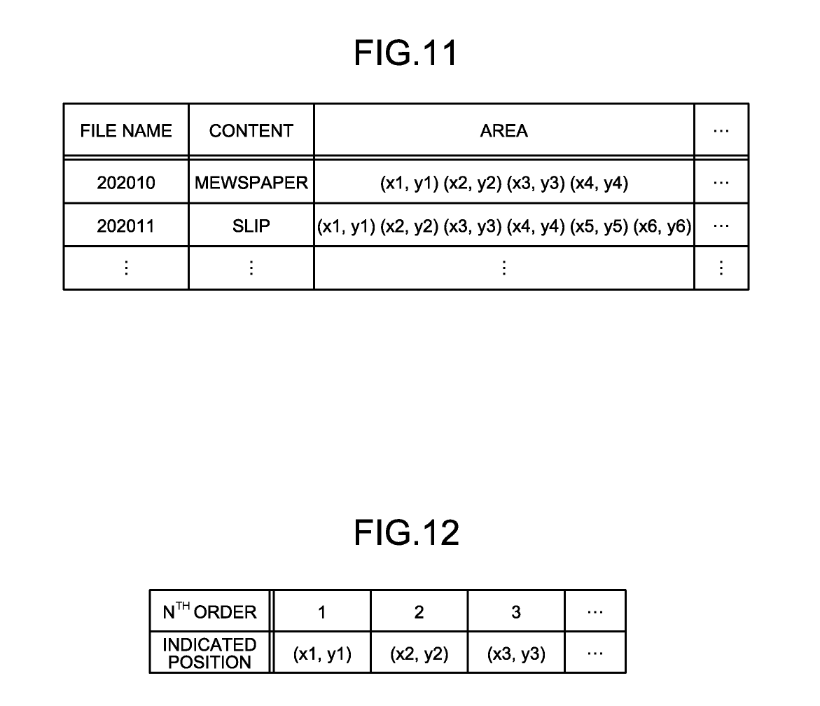

The extraction DB 32b is a database that stores therein an area that has been cut out from the projection image. FIG. 11 is a schematic diagram illustrating an example of information stored in the extraction DB 32b. As illustrated in FIG. 11, the extraction DB 32b stores therein, in an associated manner, “the file name, the content, and the area”.

The “file name” stored here indicates the file of the projection image that becomes the extraction source. The “content” is information indicating the content of the projection image that becomes the extraction source. The “area” is information indicating the area of the projection image specified by the file name and is constituted by a plurality of coordinates.

The example illustrated in FIG. 11 indicates that the projection image of the file name “202010” is a “newspaper” and indicates that the area enclosed by the four points of “(x1,y1), (x2,y2), (x3,y3), and (x4,y4)” has been extracted.

The control unit 35 is a processing unit that manages the entirety of the image processing device 30 and is, for example, an electronic circuit, such as a processor, or the like. The control unit 35 includes a projection processing unit 36, an image capture processing unit 37, an image acquiring unit 38, a color space conversion unit 39, a hand area detecting unit 40, a hand operation judgement unit 41, and a depiction management unit 42. Furthermore, the projection processing unit 36, the image capture processing unit 37, the image acquiring unit 38, the color space conversion unit 39, the hand area detecting unit 40, the hand operation judgement unit 41, and the depiction management unit 42 are an example of an electronic circuit or an example of a process performed by a processor.

The projection processing unit 36 is a processing unit that performs control of projection to the projector 3. For example, the projection processing unit 36 sends an indication, such as the start or the stop of capturing an image to the projector 3. Furthermore, the projection processing unit 36 controls the luminous at the time of projection onto the projector 3.

The image capture processing unit 37 is a processing unit that performs control of image capturing with respect to the camera 1 and the camera 2. For example, the image capture processing unit 37 sends an indication, such as the start of image capturing, or the like, to each of the cameras and allows each of the cameras to capture a projection plane.

The image acquiring unit 38 is a processing unit that acquires a captured image in the image DB 32a. For example, the image capture processing unit 37 acquires the captured image captured by each of the cameras from each of the cameras and stores the captured images in the image DB 32a.

The color space conversion unit 39 is a processing unit that converts the captured image to a color space. For example, the color space conversion unit 39 reads the captured image from the image DB 32a, converts the read captured image to a color space, and sets the upper limit and the lower limit on each of the axes of the color space. Then, the color space conversion unit 39 outputs the image converted to the color space to the hand area detecting unit 40.

Furthermore, every time a captured image is stored in the image DB 32a, the color space conversion unit 39 reads the latest captured image and performs conversion of the color space. Furthermore, regrading conversion of the color space, generally used image processing can be used.

The hand area detecting unit 40 is a processing unit that detects an area of the finger 8 from the captured image. For example, the hand area detecting unit 40 extracts a skin color area from an image that is converted to a color space by the color space conversion unit 39 and then detects that the extracted area as a hand area. Then, the hand area detecting unit 40 outputs the extracted hand area to the hand operation judgement unit 41.

The hand operation judgement unit 41 is a processing unit that judges the touch operation in which the finger 8 comes into contact with the captured image, the release operation in which the finger 8 is away from the captured image, or the like. Specifically, the hand operation judgement unit 41 specifies the trajectory of the finger 8 with respect to the captured image, detects the two-point touch operation, the drag operation, or the like, and performs the subject process. Furthermore, the hand operation judgement unit 41 detects the end of the two-point touch operation, the drag operation, or the like from the captured image that is input after the detection of the release operation, and ends the various kinds of processes.

The depiction management unit 42 is a processing unit that depicts with respect to the projection image based on various kinds of operations performed on the captured image. Specifically, the depiction management unit 42 depicts, in the projection image, during the period of time in which the finger 8 is included in the designated range of the captured image, the line sequentially connecting the designated positions designated by the finger 8. Then, if the last designated position designated by the finger 8 the last time matches the first designated position designated by the finger 8 first time, the depiction management unit 42 cuts out the projection image in the area enclosed by each of the indicated positions from the first designated position to the last designated position and stores the cut out projection image in the extraction DB 32b.

For example, the depiction management unit 42 records the position designated by the finger 8 in the captured image as the first indication point and records the position designated by the finger 8 in the subsequent captured image as the second indication point. FIG. 12 is a schematic diagram illustrating an example of indication points. As illustrated in FIG. 12, the depiction management unit 42 records the first indication point as (x1,y1) in the storage unit 32 or the like, records the second indication point as (x2,y2), records the third indication point as (x3,y3), and the like. Then, the depiction management unit 42 depicts the recorded indication point in the projection image and depicts, in the projection image, the line connecting the first indication point and the second indication point and the line connecting the second indication point and the third indication point. Then, if a fifth indication point matches the first indication point, the depiction management unit 42 extracts, as a cut-out area, an area that is enclosed by the first to the fourth indication points and stores the area in the extraction DB 32b.

Furthermore, the depiction management unit 42 further depicts, in the projection image, the line connecting from the designated position designated by the finger 8 the last time to the current position of the indicating member and may also delete, if the finger 8 moves outside the designated range of the captured image, the line from the last indicated position to the current position of the finger 8.

For example, the depiction management unit 42 depicts the line connecting from the third indication point (x3,y3) to the current position (x3,y4) of the finger 8 and deletes, if the finger 8 moves outside the range after that, the line starting from the third to the current position.

Furthermore, the line to be deleted can be arbitrarily set. For example, if the finger 8 moves outside the designated range of the captured image, the depiction management unit 42 traces back to a predetermined indicated position from among the designated indicated positions and deletes, from the projection image, the line connecting the indicated positions that are designated subsequent to the predetermined indicated position. For example, if the depiction management unit 42 selects a second indication point after the finger 8 moves outside the designated range in the state of depicting the four indication points and the three lines connecting each of the indication points, the depiction management unit 42 may also delete the portions other than the first indication point, the second indication point, and the line connecting the first indication point and the second indication point. Namely, the depiction management unit 42 deletes the subsequent indication points designated by the finger 8.

### Specific Example

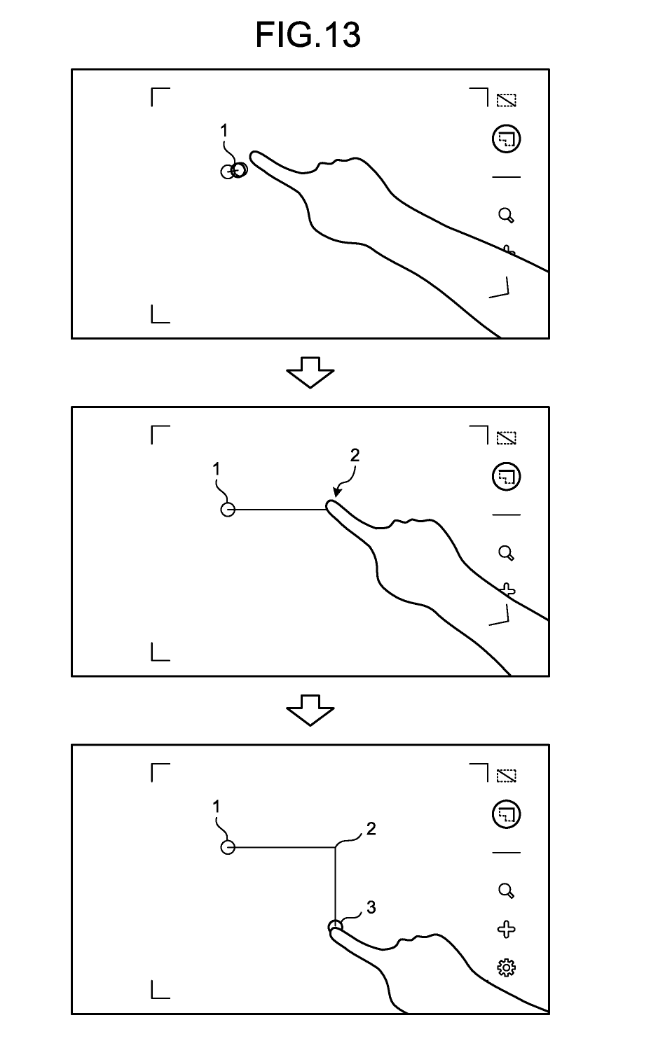

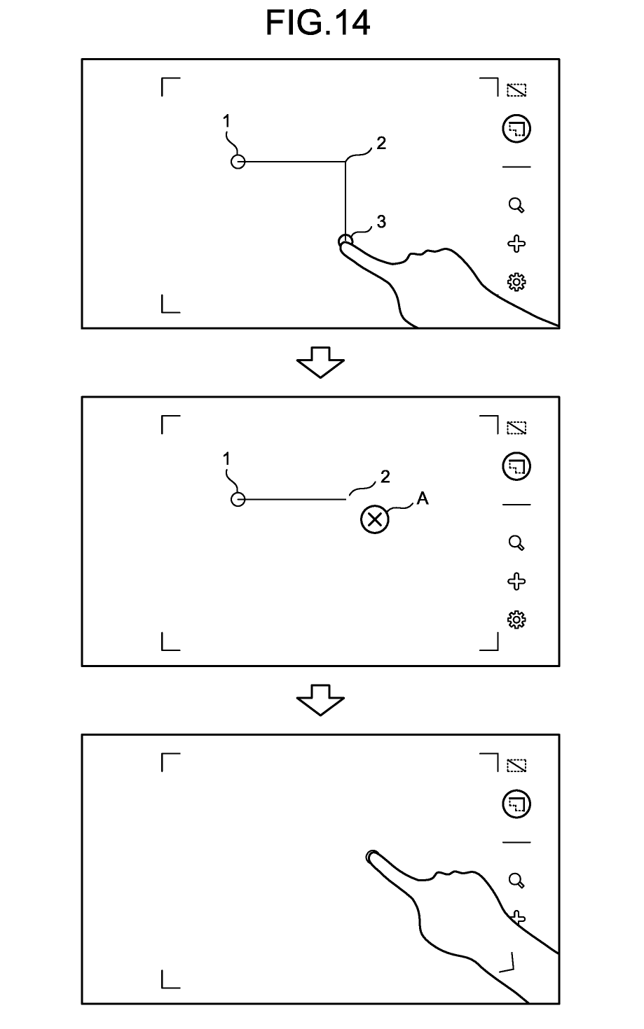

In the following, a specific example of depicting the indication points and the lines will be described with reference to FIGS. 13 and 14. FIG. 13 is a schematic diagram illustrating an operation of depicting a line connecting indication points. FIG. 14 is a schematic diagram illustrating an operation at the time of cancellation. Furthermore, the numbers illustrated in each of the drawings is the order of indications of the indicated positions and, for example, 1 indicates the position designated first.

Here, the defined indicated position is referred to as an indication point and a case of simply representing an indicated position indicates an undefined position. Furthermore, the word of define indicates that the subsequent indicated position is designated by the finger 8 and, for example, if the finger 8 designates the subsequent position after designating a certain position, the certain position is defined.

As illustrated in FIG. 13, the depiction management unit 42 depicts the first indication point indicated by the finger 8 in the projection image. Then, the depiction management unit 42 depicts the second indication point indicated by the finger 8 in the projection image and depicts the line connecting the first indication point and the second indication point. Furthermore, after that, the depiction management unit 42 depicts the line connecting the current position of the finger 8 (in FIG. 13, the third position) and the second indication point. Namely, at the third position, the finger 8 is in a contact state and this position is undefined.

As described above, the depiction management unit 42 performs depiction in the projection image by defining, as the indication point, the position that is indicated by the finger 8 and that is away from the projection plane and by defining the line between the indication points. Furthermore, the depiction management unit 42 depicts, in the projection image, while following the position that is being indicated by the finger 8, the line connecting the position that is being indicated and the last defined indication point. In this way, the depiction management unit 42 defines the cut-out area in the projection image.

Then, as illustrated in FIG. 14, if the finger 8 is located outside the image capturing range of the camera in this state, i.e., in the state in which the third indicated position is undefined, the depiction management unit 42 deletes, from the projection image, the line connecting the second indication point that is defined the last time and the third position. Furthermore, the depiction management unit 42 depicts a cancel button A that deletes all of the depictions near the second indication point that is defined the last time.

Namely, if the finger 8 is not included in the captured image captured by each of the cameras, the depiction management unit 42 cancels the third position that is being instructed and then depicts, in the projection image, the indication points and the line that have already been defined.

Then, if the cancel button is selected, the depiction management unit 42 cancels the indication points that have been defined until now. Namely, if each of the cameras captures the image of the finger 8 that selects the cancel button, the depiction management unit 42 deletes the indication points and the line from the projection image. In this way, the depiction management unit 42 modifies the cut-out area in the projection image.

Flow of the Area Process

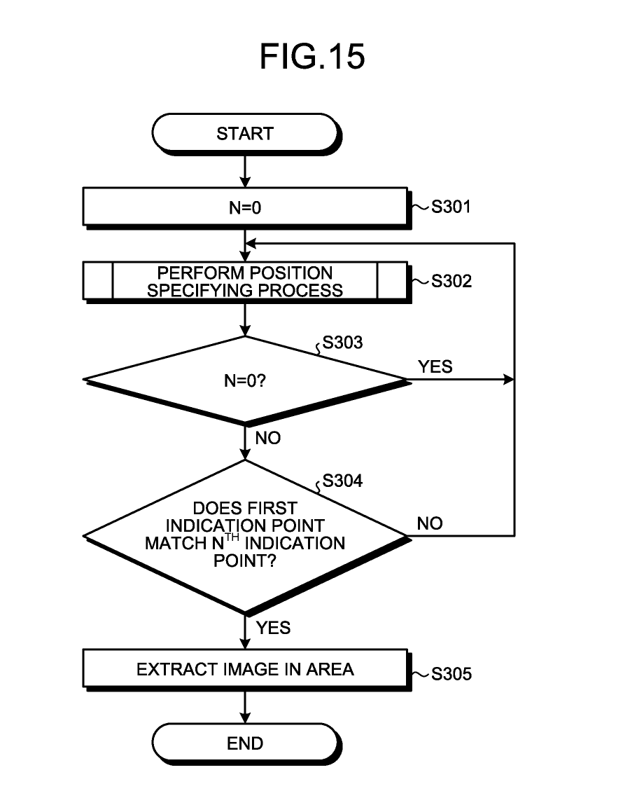

In the following, the process performed by the image processing device 30 according to the second embodiment will be described. FIG. 15 is a flowchart illustrating the flow of an area confirming process according to the second embodiment.

As illustrated in FIG. 15, if a process is started, the depiction management unit 42 in the image processing device 30 substitutes 0 for the coefficient N (Step S301) and performs a position specifying process (Step S302).

If the position specifying process has been ended, the depiction management unit 42 determines whether the coefficient N is 0 (Step S303). At this point, if the coefficient N is 0 (Yes at Step S303), the depiction management unit 42 repeatedly proceeds to Step S302.

In contrast, if the coefficient N is not 0 (No at Step S303), the depiction management unit 42 determines whether the first indication point matches the N^{th} indication point (Step S304).

At this point, if the first indication point does not match the N^{th} indication point (No at Step S304), the depiction management unit 42 repeatedly proceeds to Step S302. In contrast, if the first indication point match the N^{th} indication point (Yes at Step S304), the depiction management unit 42 extracts an image within the area enclosed by the first indication point to the N^{th} indication point and stores the image in the extraction DB 32b (Step S305).

Position Specifying Process

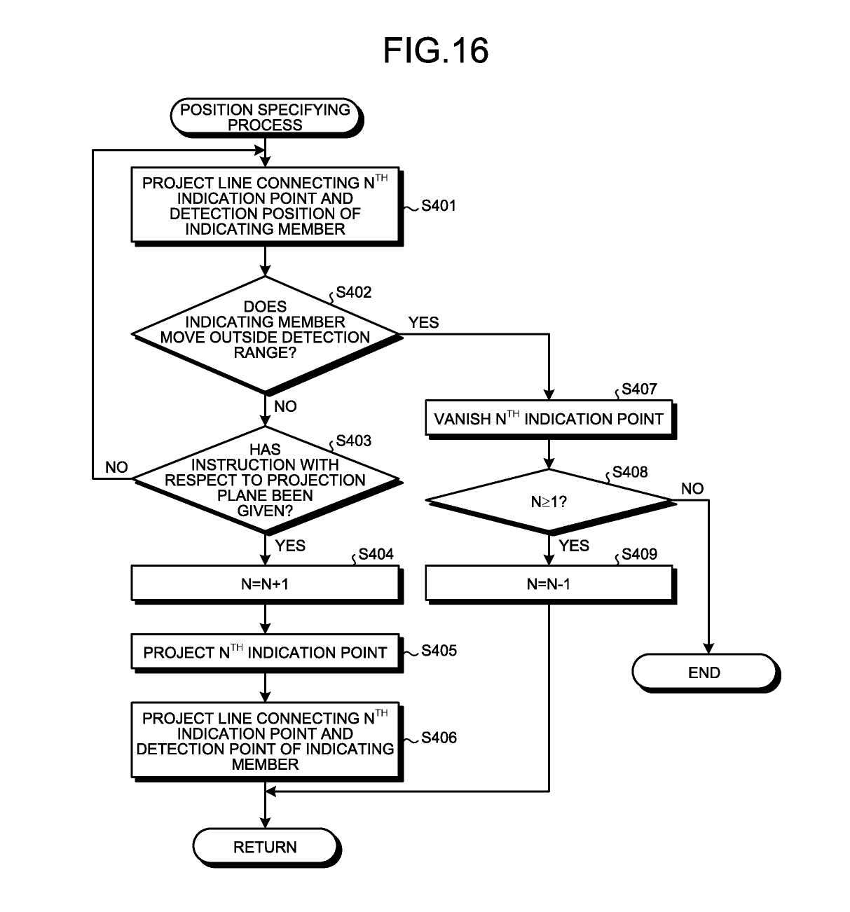

In the following, a position specifying process performed at Step S302 illustrated in FIG. 15 will be described. FIG. 16 is a flowchart illustrating the flow of a position specifying process.

As illustrated in FIG. 16, the depiction management unit 42 projects the line connecting the N^{th} indication point and the detection position of the indicating member (the finger 8) (Step S401). Then, the depiction management unit 42 determines whether the indicating member moves outside the detection range (Step S402).

At this point, if the indicating member is within the detection range (No at Step S402), the depiction management unit 42 determines whether an instruction with respect to the projection plane has been given (Step S403). If an instruction with respect to the projection plane has been given (Yes at Step S403), the depiction management unit 42 increments the coefficient N (Step S404) and projects the N^{th} indication point (Step S405).

Furthermore, the depiction management unit 42 projects the line connecting the N^{th} indication point and the N+1^{th} indication point (Step S406) and returns to the process illustrated in FIG. 15. Furthermore, at Step S403, if an instruction with respect to the projection plane has not been given (No at Step S403), the depiction management unit 42 repeats the processes at Step S401 and the subsequent processes.

Furthermore, at Step S402, if the indicating member is outside the detection range (Yes at Step S402), the depiction management unit 42 vanishes the N^{th} indication point (Step S407) and determines whether the coefficient N is equal to or greater than 1 (Step S408).

At this point, if the coefficient N is less than 1 (No at Step S408), the depiction management unit 42 ends the process. In contrast, if the coefficient N is equal to or greater than 1 (Yes at Step S408), the depiction management unit 42 decrements the coefficient N by 1 (Step S409) and returns to the process illustrated in FIG. 15.

Effect

As described above, if the finger 8 moves outside the designated range, the image processing device 30 can delete, at the time of area selection, the last side of the selected area and returns to the end point of the side immediately previous to the last side. After having performed an undo operation, the image processing device 30 also displays an all-cancel button and, if the subject button is selected, all of the designated areas can be reset.

Accordingly, the image processing device 30 can speedily perform the undo or the reset operation, such as a cut out operation, or the like, in the clipping process. In this way, the image processing device 30 can improve the operability at the time of operation of a projection image by using an indicating member.

### [c] Third Embodiment

In the above explanation, a description has been given of the embodiments according to the present invention; however, the present invention may also be implemented with various kinds of embodiments other than the embodiments described above.

Height Threshold and the Number of Protection Stages

In the first embodiment, a description has been given of an example of setting the height threshold and the number of protection stages; however, the embodiment is not limited to this and one or both the height threshold and the number of protection stages can be arbitrarily set. For example, the image processing device 10 can dynamically change only the height threshold in accordance with the process or can dynamically change only the number of protection stages. Furthermore, the image processing device 10 can also dynamically change, in accordance with the process, the height threshold or the number of protection stages of the touch operation and can also dynamically change, in accordance with the process, the height threshold or the number of protection stages of the release operation.

Undo Operation

In the second embodiment, a description has been given of an example in which, when the finger 8 moves outside the range, the image processing device 30 deletes the line to the position that is currently indicated by the finger 8 and defines the position up to the immediately previous indication point; however, the embodiment is not limited to this.

For example, it is possible to previously set the indication point that defines the indication point indicated two steps before. In this way, the image processing device 30 defines the indication points indicated up to the second from the last and deletes the last indication point, the last position of the finger 8, the line to the last indication point, and the line to the last position.

Furthermore, the image processing device 30 can also dynamically change the return destination in accordance with the speed of the finger 8 that is the indicating member. For example, the image processing device 30 can specify the return destination in accordance with the number of captured images leading to outside the designated range of the finger 8. For example, if the number of captured images that do not include the finger captured by each of the cameras is equal to or less than three, the image processing device 30 defines the indication points up to the last indication point and, if the state is other than this, the image processing device 30 defines the indication points up to second from the last.

Designated Range

In the second embodiment, a description has been given of an example in which it is judged that the finger 8 moves outside the designated range when the finger 8 is not included in the captured image; however, the embodiment is not limited to this. For example, the image processing device 30 designates the predetermined area of the captured image outside the designated range and, if an image in which the finger 8 enters the designated area that is previously designated is captured, the image processing device 30 can also judge that the finger 8 moves outside the designated range.

System

Furthermore, the components of each device illustrated in the drawings are not always physically configured as illustrated in the drawings. Namely, the components may also be configured by separating or integrating any of the devices. Furthermore, all or any part of the processing functions performed by each device can be implemented by a CPU and by programs analyzed and executed by the CPU or implemented as hardware by wired logic.

Of the processes described in the embodiment, the whole or a part of the processes that are mentioned as being automatically performed can also be manually performed, or the whole or a part of the processes that are mentioned as being manually performed can also be automatically performed using known methods. Furthermore, the flow of the processes, the control procedures, the specific names, and the information containing various kinds of data or parameters indicated in the above specification and drawings can be arbitrarily changed unless otherwise stated.

Hardware

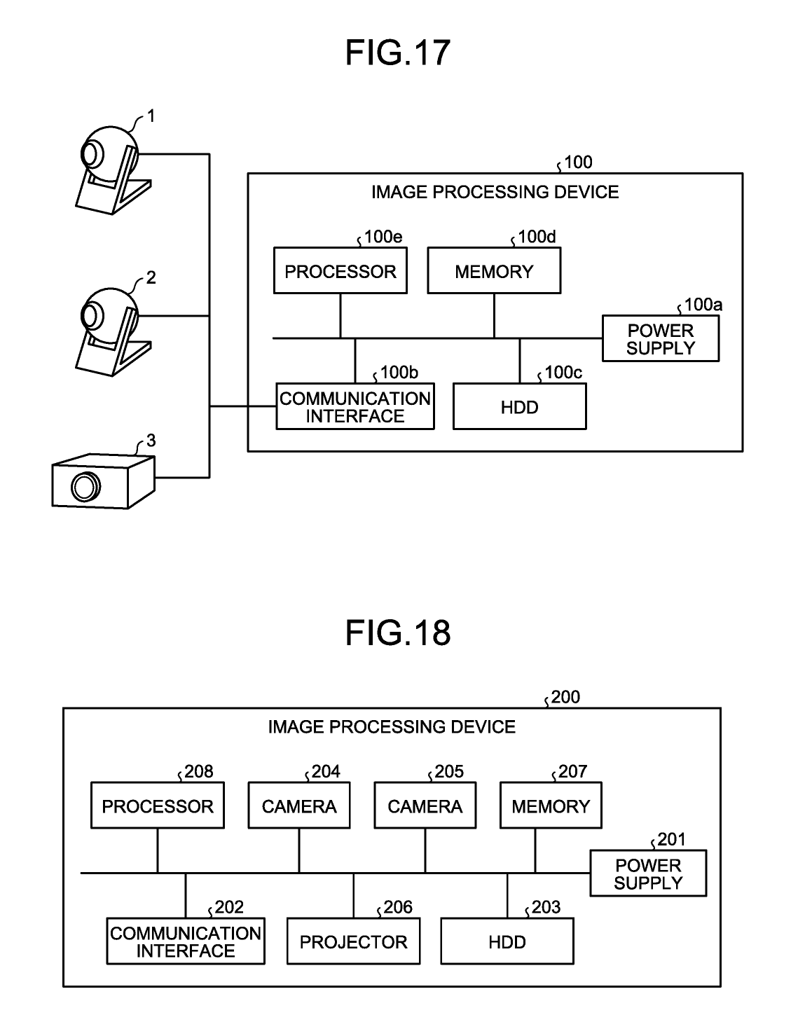

FIG. 17 is a schematic diagram illustrating an example of the hardware configuration of an image processing device according to the first embodiment and the second embodiment. Furthermore, because the image processing devices according to the first embodiment and the second embodiment have the same hardware configuration, here, a description will be given as an image processing device 100.

As illustrated in FIG. 17, the image processing device 100 includes a power supply 100a, a communication interface 100b, a hard disk drive (HDD) 100c, a memory 100d, and a processor 100e. Furthermore, each of the units illustrated in FIG. 17 is mutually connected by a bus or the like.

The power supply 100a acquires electrical power supplied from outside and allows each of the units to be operated. The communication interface 100b is an interface that controls communication with other devices and is, for example, a network interface card. The HDD 100c stores therein the programs that operate the functions, the DBs, and the tables illustrated in FIG. 2, FIG. 10, or the like.

By reading the program that executes the same process as that performed by each of the processing units illustrated in FIG. 2, FIG. 10, or the like from the HDD 100c or the like and loading the read programs in the memory 100d, the processor 100e allows the process that executes each of the functions described with reference to FIG. 2, FIG. 10, or the like to be operated.

Namely, this process performs the same function as that performed by each of the processing units included in the image processing device 10 or the image processing device 30. Specifically, the processor 100e reads, from the HDD 100c or the like, the programs having the same function as those of the projection processing unit 16, the image capture processing unit 17, the image acquiring unit 18, the color space conversion unit 19, the hand area detecting unit 20, the hand operation judgement unit 21, the operation execution unit 22, and the like. Then, the processor 100e executes the process that executes the same processes as those performed by the projection processing unit 16, the image capture processing unit 17, the image acquiring unit 18, the color space conversion unit 19, the hand area detecting unit 20, the hand operation judgement unit 21, and the operation execution unit 22.

Furthermore, the processor 100e reads, the HDD 100c or the like, the programs that have the same functions as those of the projection processing unit 36, the image capture processing unit 37, the image acquiring unit 38, the color space conversion unit 39, the hand area detecting unit 40, the hand operation judgement unit 41, the depiction management unit 42, and the like. Then, the processor 100e executes the process that executes the same processes as those performed by the projection processing unit 36, the image capture processing unit 37, the image acquiring unit 38, the color space conversion unit 39, the hand area detecting unit 40, the hand operation judgement unit 41, and the depiction management unit 42.

In this way, by reading and executing the programs, the image processing device 100 is operated as an information processing apparatus that executes an input/output method. Furthermore, the image processing device 100 can also implement the same function as that described above in the embodiments by reading the programs described above from a recording medium by a medium reading device and executing the read programs described above. Furthermore, the programs described in the other embodiment are not limited to be executed by the image processing device 100. For example, the present invention may also be similarly used in a case in which another computer or a server executes a program or in a case in which another computer and a server cooperatively execute the program with each other.

Casing

Furthermore, in the first embodiment and the second embodiment described above, descriptions have been given of an example in which each of the cameras, the projector 3, and the image processing device 100 are implemented by separate casings; however, the embodiment is not limited to this but may also be implemented by the same casing.

FIG. 18 is a schematic diagram illustrating an example of the hardware configuration of an image processing device according to the first embodiment and the second embodiment. Furthermore, because the image processing devices according to the first embodiment and the second embodiment have the same hardware configuration, here, a description will be given as an image processing device 200.

As illustrated in FIG. 18, the image processing device 200 includes a power supply 201, a communication interface 202, an HDD 203, a camera 204, a camera 205, a projector 206, a memory 207, and a processor 208. Furthermore, each of the units illustrated in FIG. 18 is mutually connected to a bus or the like.

The power supply 201 acquires electrical power supplied from outside and allows each of the units to be operated. The communication interface 202 is an interface that controls communication with other devices and is, for example, a network interface card. The HDD 203 stores therein the programs that operate the functions the DBs, and the tables illustrated in FIG. 2, FIG. 10, or the like.

The camera 204 performs the same function as that performed by the camera 1 illustrated in FIG. 1, the camera 205 performs the same function as that performed by the camera 2 illustrated in FIG. 1, and the projector 206 performs the same function as that performed by the projector 3 illustrated in FIG. 1.

Similarly to FIG. 17, by reading the program that executes the same process as that performed by each of the processing units illustrated in FIG. 2, or the like from the HDD 203, or the like and loading the read programs in the memory 207, the processor 208 allows the process that executes each of the functions described with reference to FIG. 2, FIG. 10, or the like to be operated.

In this way, by reading and executing the programs, the image processing device 200 is operated as an information processing apparatus that executes the input/output method. Furthermore, the image processing device 200 can also implement the same function as that described above in the embodiments by reading the programs described above from a recording medium by a medium reading device and executing the read programs described above. Furthermore, the program described in the other embodiment is not limited to be executed by the image processing device 200. For example, the present invention may also be similarly used in a case in which another computer or a server executes a program or in a case in which another computer and a server cooperatively execute the program with each other.

According to an aspect of the embodiments, it is possible to improve the operability in a case when a projection image is operated by using an indicating member.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An image processing device comprising:
a processor configured to:
project a projection image onto a projection plane;
capture the projection plane;
specify a process to be performed on the projection image; and
change, based on the specified process, a start trigger of the start of the process or a height threshold of an indicating member included in a captured image from the projection plane, the height threshold indicating a threshold which is used for judgement of a touch operation in which the indicating member comes into contact with the projection image or a release operation in which the indicating member is away from the projection image.

2. The image processing device according to claim 1, wherein the processor is further configured to:
specify, after the touch operation has been detected, based on the operation content of the indicating member with respect to the projection image, a type of a clipping process that is processing target and perform the clipping process with the specified type, and
change the height threshold that is used to detect the release operation to a threshold that is associated with the type of the clipping process that has been performed.

3. The image processing device according to claim 2, wherein the processor is further configured to:
in a case of a drag process in which the indicating member directly comes into contact with the projection image and moves the projection image, increase the height set to the threshold higher than that set to the processes other than the drag process.

4. The image processing device according to claim 2, wherein the processor is further configured to:
decide, in accordance with the type of the performed clipping process, the start trigger of the clipping process to be set in the captured image with what number of frame from among the captured images subsequent to the captured image in which the release operation has been detected.

5. The image processing device according to claim 2, wherein the processor is further configured to:
in a case of a drag process in which the indicating member directly comes into contact with the projection image and moves the projection image, set the number of frames set to the start trigger greater than that set to the processes other than the drag process.

6. An image processing method comprising:
projecting a projection image onto a projection plane, using a processor;
capturing the projection plane, using the processor;
specifying a process to be performed on the projection image, using the processor; and
changing, based on the specified process, a start trigger of the start of the process or a height threshold of an indicating member included in a captured image from the projection plane, the height threshold indicating a threshold which is used for judgement of a touch operation in which the indicating member comes into contact with the projection image or a release operation in which the indicating member is away from the projection image, using the processor.

7. A computer-readable recording medium having stored therein an image processing program that causes a computer to execute a process comprising:
projecting a projection image onto a projection plane;
capturing the projection plane;
specifying a process to be performed on the projection image; and
changing, based on the specified process, a start trigger of the start of the process or a height threshold of an indicating member included in a captured image from the projection plane, the height threshold indicating a threshold which is used for judgement of a touch operation in which the indicating member comes into contact with the projection image or a release operation in which the indicating member is away from the projection image.

8. An image processing device comprising:
a processor configured to:
project a projection image onto a projection plane;
capture the projection plane;
depict, in the projection image, during a period of time in which an indicating member is included in a designated range of a captured image captured, a line sequentially connecting designated positions that are indicated by the indicating member; and
trace, when the indicating member moves outside the designated range of the captured image, back to a predetermined designated position from among the designated positions and delete, from the projection image, the line connecting the designated positions that are designated subsequent to the predetermined designated position.

9. The image processing device according to claim 8, wherein the processor is further configured to:
depict, in the projection image, a line connecting from the designated position that is indicated by the indicating member the last time to the current position of the indicating member, and
when the indicating member moves outside the designated range of the captured image, delete the line starting from the last designated position to the current position of the indicating member.

10. The image processing device according to claim 9, wherein the processor is further configured to:
depict, in the vicinity of the last designated position in the projection image, a button that performs an operation of canceling all of the designated positions and the lines.

11. The image processing device according to claim 8, wherein the processor is further configured to:
cut out, when the last designated position that is designated by the indicating member the last time matches a first designated position that is designated by the indicating member first time, the projection image in an area enclosed by each of the designated positions starting from the first designated position to the last designated position and store the cut out projection image in a predetermined storage unit.

12. An image processing method comprising:
projecting a projection image onto a projection plane, using a processor;
capturing the projection plane, using the processor;
depicting, in the projection image, during a period of time in which an indicating member is included in a designated range of a captured image, a line sequentially connecting designated positions that are indicated by the indicating member, using the processor; and
tracing, when the indicating member moves outside the designated range of the captured image, back to a predetermined designated position from among the designated indicated positions and deleting from the projection image, the line connecting the designated positions that are indicated subsequent to the predetermined designated position, using the processor.

13. A computer-readable recording medium having stored therein an image processing program that causes a computer to execute a process comprising:
projecting a projection image onto a projection plane;
capturing the projection plane;
depicting, in the projection image, during a period of time in which an indicating member is included in a designated range of a captured image, a line sequentially connecting designated positions that are indicated by the indicating member; and
tracing, when the indicating member moves outside the designated range of the captured image, back to a predetermined designated position from among the designated indicated positions and deleting from the projection image, the line connecting the designated positions that are designated subsequent to the predetermined designated position.
